(19) United States
(12) Patent Application Publication
(10) Pub. No.: US 2020/0066121 A1
(43) Pub. Date: Feb. 27, 2020

(54) WIRELESS SURVEILLANCE SECURITY SYSTEM AND METHOD

(71) Applicant: HERBERT S. KOBAYASHI, WEBSTER, TX (US)

(72) Inventor: HERBERT S. KOBAYASHI, WEBSTER, TX (US)

(21) Appl. No.: 16/108,590

(22) Filed: Aug. 22, 2018

(51) Int. Cl. G08B 13/196; G01S 13/02; G08B 13/19; H04N 7/18

(52) U.S. Cl. CPC G08B 13/1963; G08B 13/19632; H04N 7/186; G08B 13/19; G01S 13/02

(57) ABSTRACT

A lightweight, hinged antenna pole may deployed in an upright position with a plurality of components mounted upon it for a scanning surveillance system. A pylon or heavy anchor may support the antenna and transmitters attached to the lightweight, hinged antenna pole. A rotor may be coupled to the pole to oscillate the wireless cameras or receivers using an AC power source. A hinge is bolted to an anchor as well as to the lightweight antenna pole. A set of electronic chips may encode and decode data from a plurality of inputs attached to the antenna pole. The data may be transmitted through an audio port of a camera to a receiver monitor system. The data may frame synced for viewing by a user at any time.

### BACKGROUND OF THE INVENTION

### Field of the Invention

The present invention relates generally to rotatable wireless video surveillance systems and, more particularly, to a mechanism and means of providing a wireless signal for the deployment of surveillance antenna pole which may allow rotation of video cameras, lights, and the like mounted a drive mechanism.

### Background of the Invention

It is highly desirable for some surveillance systems to be lightweight and easily deployed. Heavy or bulky material is unwieldy and difficult to erect without the use a large equipment such as a bucket truck. This increases the complexity of using such a system along with increasing the amount of time required to set up and increases costs. In order to set up these systems, large vehicles may additionally be required to transport heavy antenna poles, audio and video equipment, concrete, as well as various other required component and tools to fully set up and install the system. Further servicing the pole and equipment would therefore also require heavy equipment when maintenance is needed.

Use of wireless cameras by oscillating or rotating the wireless surveillance videos cameras and other components may have angular coverage limited to around 30 degrees of file of view and radial distance of around 30 feet for audio. Additionally, the audio, video, and motion must be continuously monitored. In low light conditions, the field of view may be seriously decreased thereby limiting the effective range of surveillance monitoring. Wireless systems may also utilize RF signals that may limited to around 150 feet indoors and 450 feet outdoors with non-directional Omni antennas.

Cameras to rotate or pan to cover a wider range of area. Prior art video monitoring systems are typically pan and tilt units that utilize a processor to control the movement or pan of the cameras. These systems advantageously utilize adjustable pan angles that are computer controllable as to angle and sometimes as to speed for the pan. It is sometimes desirable to be able to add lights, radar, Doppler radar, motion detectors, PIR detectors, and the like to the camera mounting bracket, for example, to detect the direction of an object such as a bullet or for more context such as temperature detectors for fire detection. These signals may then be verified or checked visually by use of the camera.

Wireless security systems may be prohibitively expensive or complex to deploy. The systems may require a plurality of inputs to provide the data signal from a transmitter to a receiver. Additionally, prior art systems may be limited in range or ability to transmit the signals through obstructions such as walls, doors, or the like.

The following patents discuss background art related to the above discussed subject matter:

U.S. patent application Ser. No. 15/149,422, filed May 9, 2016, to Herbert Kobayashi, discloses a television based alarm system providing video streams from multiple cameras produced at a first location that is transmitted via a radio transmitter to a secondary location. Motion detector signals from a plurality of motion detectors at the first location are utilized to indicate when and which cameras are likely to see an intruder based on when and which motion detectors are tripped. In a first type of encoder/decoder, motion detectors are connected to LEDS for encoding and then decoded utilizing photo electric cells. In another encoder/decoder, motion detector signals are used to produce a digital word that is added to the video signal and then decoded as a digital word. An output device such as a printer can be used to print the motion detector number, date, and time print out and sound an alarm.

U.S. Pat. No. 9,690,184, issued Jun. 27, 2017, to Herbert Kobayashi, discloses a rotatable video surveillance system is configured with a drive mechanism that rotates a bracket for a camera up to 360 degrees. The drive mechanism comprises a plurality of gears that rotate a camera back and forth up to at least 180 degrees. The drive mechanism comprises a control arm connecting between the first gear and a second gear, and a third output gear connected to a rotatable bracket. The drive mechanism typically rotates the bracket at a non-linear speed. A switch may be connected to produce back and forth rotation or pause. An electronic control can be used to control the speed of said drive mechanism and/or pan angle and pause. The rotatable surveillance camera covers at least up to 180 degrees. At night, a camera may see 10 to 30 feet, but with a spotlight the camera may see 300′ to 600′. Doppler radar range is about 1 mile.

The above patents are hereby incorporated in their entirety herein by reference.

There exists a need for a be lightweight and easily deployed camera system. An improved system that is easy to set up while providing an increased effective range is desirable.

Consequently, those skilled in the art will appreciate the present invention.

### SUMMARY OF THE INVENTION

A primary object of the present invention is to provide a surveillance system which may be quickly deployed at low cost, decreased time, and with increased coverage.

Another object of the present invention is to provide a lightweight, hinged antenna pole to easily erect a scanning surveillance system which may rotate 360 degrees.

Still another object of the present invention is to provide an anchor or pylon to support a lightweight, hinged antenna pole thereby reducing the necessity for heavy equipment during deployment.

Yet another object of the present invention is to provide an oscillating rotor coupled to a lightweight, hinged antenna pole thereby allowing for a scanning surveillance system capable of mounting a plurality of components to be utilized for increased surveillance with camera information to help discrete detection such as with time and date printing to check an alarm or with time and date for a video camera.

Another object of the present invention is to provide an improved wireless surveillance security wherein an encoder chip may provide data to an audio port of a wireless camera which may be transmitted to a receiver for a user to monitor the security system and sending the signal to a decoder chip for processing and storage.

These and other objects, features, and advantages of the present invention will become clear from the figures and description given hereinafter. It is understood that the objects listed above are not all inclusive and are only intended to aid in understanding the present invention, not to limit the bounds of the present invention in any way.

### BRIEF DESCRIPTION OF THE DRAWINGS

The above general description and the following detailed description are merely illustrative of the generic invention, and additional modes, advantages, and particulars of this invention will be readily suggested to those skilled in the art without departing from the spirit and scope of the invention. A more complete understanding of the invention and many of the attendant advantages thereto will be readily appreciated by reference to the following detailed description when considered in conjunction with the accompanying drawings, wherein like reference numerals refer to like parts and wherein:

FIG. 1 is a schematic diagram showing a front view lightweight, hinged antenna pole deployed in un upright position with a plurality of components mounted upon it for a scanning surveillance system in accord with one possible embodiment of the present invention.

FIG. 2 is a schematic diagram showing a side view of a lightweight, hinged antenna pole deployed in an upright position with a communication receiver attached in accord with another possible embodiment of the present invention.

FIG. 3 is a perspective view of the hinge in an open position that may be attached to a lightweight antenna pole for quickly deployment in accord with another possible embodiment of the present invention.

FIG. 4 is a perspective view of the hinge in an open position that may be attached to a lightweight antenna pole for quickly deployment in accord with another possible embodiment of the present invention. The hinge comprises a bolt plate that may be attached to an anchor or pylon which may be used a base to support erection of the lightweight antenna pole.

FIG. 5 is a side view of the hinge in a closed position that may be attached to a lightweight antenna pole for quickly deployment in accord with another possible embodiment of the present invention. The hinge comprises a bolt plate that may attached to an anchor or pylon which may be used a base to support erection of the lightweight antenna pole.

FIG. 6 is a schematic view of a surveillance system comprising a set of electronic chips with a plurality of data inputs wherein the data may be encoded and transmitted over an audio channel of a camera wherein an antenna sends the signals to a receiver for viewing, decoding, and/or storing on a storage device.

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

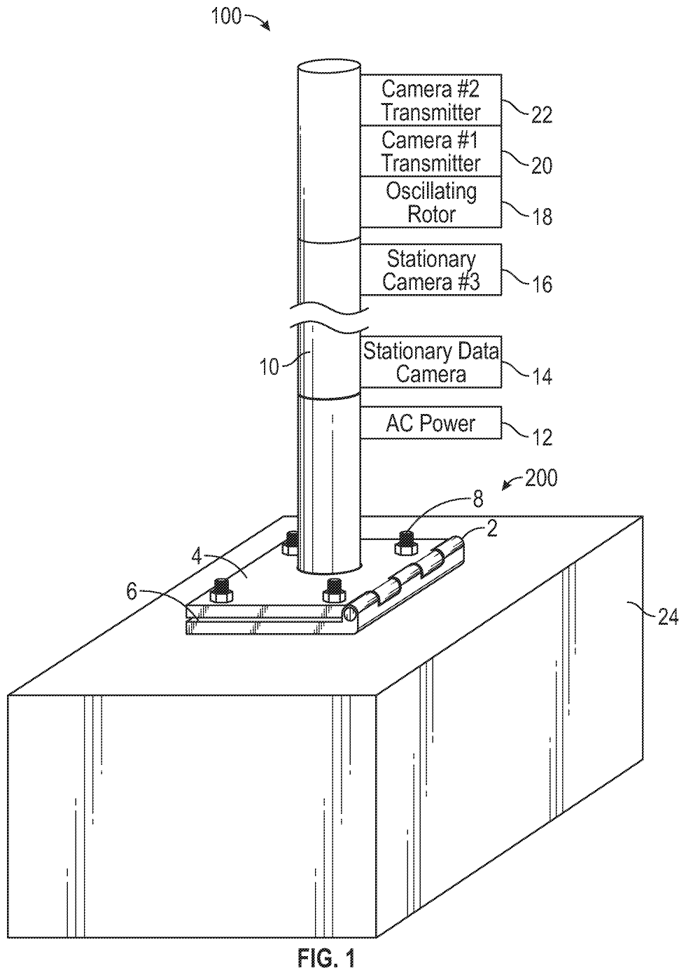

Referring now to the drawings and more specifically to FIG. 1, a schematic diagram is shown of a front view of lightweight, hinged antenna pole deployed in an upright position with a plurality of components mounted upon it for a wireless surveillance system 100 in accord with one possible embodiment of the present invention. A pylon 24 or heavy anchor may support the antenna and transmitters attached to the lightweight, hinged antenna pole 10. A rotor 18 may be coupled to the pole 10 to oscillate the wireless cameras or receivers using an AC power source 12. A hinge 2 is bolted to the anchor 24, which may also be referred to as a pylon or base, as well as to the lightweight antenna pole 10. The hinge 2 comprises a bottom bolt plate 6 and a top bolt plate 4. The bottom bolt plate 6 is attached to the anchor 24 which adds support to the lightweight antenna pole 10. The top bolt plate 4 is attached to the bottom of the lightweight antenna pole 10.

In operation, after attaching the top 4 and bottom bolt plates 4,6, a user may easily erect the antenna 10 to an upright position by lifting the lightweight antenna pole 10 so that the bottom and top bolt plates 4,6 come into contact. The bolt plates may then be locked into place to securely hold the lightweight antenna pole 10 in the upright position.

The lightweight antenna pole 10 may preferably be constructed of aluminum, however other metals, composites, wood, or suitable material may be used. In a preferred embodiment, utilizing an aluminum lightweight antenna pole 10 may achieve better RF coverage by reducing interference between transmitter and receivers. Moreover, costs may be greatly reduced by use of aluminum agricultural irrigation poles. In one possible embodiment, the lightweight antenna pole may be 20, 40, or 60 feet high to prevent RF signal interference between a transmitter and receiver. This advantageously reduces the need to use a large bucket truck to set up. Additionally, the hinge 2 may also be constructed of aluminum or other materials such as other metals, composites, wood, or other suitable materials. Because the lightweight antenna pole 10 is hinged, it is able to be serviced much easier. Access to a plurality of components can be expedited with less equipment required to maintain, adjust, add, or replace transmitters, receivers, or other desired components. The lightweight antenna pole 10 can be lowered with ease without the use of machinery such as a bucket truck although the total height of the of the lightweight antenna pole may 20, 40, 60, or 70 feet. This decreases the amount of time required to service the surveillance system 100 as well as increases the safety involved. In other embodiments, the height of the lightweight antenna pole 10 may be greater than 70 feet or less than 70 feet depending on the desired height and components to adequately provide surveillance coverage.

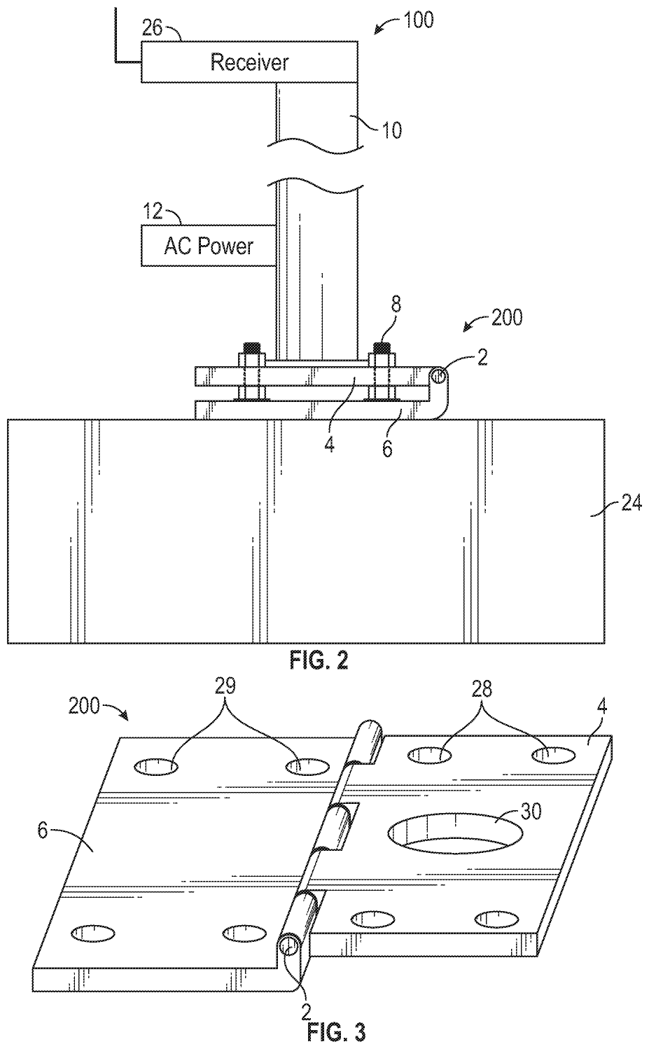

Referring to FIG. 2, a schematic diagram is shown a side view of a lightweight, hinged antenna pole deployed in an upright position with a communication receiver for a wireless surveillance system 100 attached in accord with another possible embodiment of the present invention. In one possible embodiment, an oscillating rotor 18 may be mounted to the lightweight antenna pole 10 so that the rotor 18 is at the top of the lightweight antenna pole 10 when in the upright position. Mounted to the antenna pole 10 may be a plurality of components such as a stationary camera 16, stationary data camera 12, camera transmitter 20, and camera transmitter 22. The oscillating rotor 18 may also connect to other video cameras, data camera, PIR motion detector, Doppler radar, fire detectors, or other like component. A plurality of other desired components may be used such as a video camera, spotlight, rain gauge, radiation detector, paint gun, Doppler radar, radar unit, or other like desired directional sensor or component. While the term directional apparatus is used in the claims, it will be understood that other types of sensors or detectors could also be used such as smoke, fire, CO2 detectors, temperature, wind speed, rain, gas, pollution, radiation, and the like so that motion detectors refers to other types of detectors which could produce information viewed by a particular camera. As well, many types of motion sensor detectors could be used such as radar, thermal, magnetic, ultrasonic or the like. Detectors may or may not be automatically reset after time or may require manual resetting.

In another possible embodiment, the mounted components may need to be in a stationary position to properly transmit or receive signals. Therefore, the oscillating rotor 18 may be configured to momentarily pause rotation to allow any signals to be received or transmitted. The rotating components may be hard wired or use slip rings to allow 360 degree rotation. In another possible embodiment, components such as stationary cameras 14, 16 or stationary data receivers and transmitters may be mounted to the lightweight antenna pole so that they are permanently stationary.

With the use of a spotlight and a camera, there is an increase in surveillance range. A stationary camera covers about thirty degrees angular and stationary Doppler radar covers eight angular degrees. At night a camera may see 10 to 30 feet, however with a spotlight the camera may see 300′ to 600′ feet out and, additionally, with the Doppler radar range is about 1 mile. The rotational scanning axis the oscillating rotor may 360 degrees or less. If the rotation is configured to be less than 360 degrees, the electrical connections to the directional components may be mounted to be hard wired resulting in decreased cost as well as greater reliability.

The video camera or cameras can obtain a visual picture of the area under surveillance of the area, however the discrete detectors may need to be checked by a user. Discrete detectors such as motion detectors and Doppler radars and laser beam detectors may pick up a person as well as birds and insects so this may require a visual check. Code detectors may identify for example friend or foe (IFOF), and may require a visual check. Infrared temperature detector for fire detection may require a visual check not only to determine the location of the fire but also the intensity. More than one Doppler radar may detect the direction of a path of a bullet or IFOF.

To increase the field of view of the camera, the rotor 18 may oscillate up to 360 degrees or be rotated by slips rings to allow for the electrical connections to be rotated at any angle. Additionally, to increase the radial range an LED motor spot light, LED visible, or less visible LED may be utilized. The less visible LED can be converted to be more visible at a monitor to increase the radial range to approximately 30 to 600 feet. Data may be converted from one camera by turning on the LEDs or using an audio channel for PIR (passive infrared) motion detection to around 30 feet. Doppler radar may detect motion through windows and doors from 10 feet to up to one mile. Radiation may be detected by Geiger counter pulses. A smoke detector may be activated in the presence of smoke indicating the possibility of fire and sound a fire alarm. Weather monitoring may be accomplished by wind speed monitor and water flood alarm. A disadvantage that prior art systems encounter when using an audio channel to transmit and receive data occurs due to the spread spectrum transmitter and receiver in the relay link thereby being less reliable.

To overcome the limitations of prior art systems, the present invention may combine video and data signals over the same video information system to determine a friend or foe in real time. A sensor may initiate an alarm or alert which may be sent to a user or recorded to data storage indicating a friend or foe with a tag of the identification along with the date and time. A user can review at any time the alerts in real time or stored without requiring excessive time wasted wading through large portions of the recordings. Wireless surveillance systems may provide an effective range of 150 feet indoors and 450 feet outdoors with a non-directional Omni antenna. This range may be increased to around approximately 1800 feet by high gain, directional antennas, and with a spread spectrum transmitter and receiver this may still be increased further to a range of about 3 miles at 0.2 watt power. By combining video and audio signals, possibly by using existing security monitoring components such as cameras and audio recorders, a user may save money in their monthly bills.

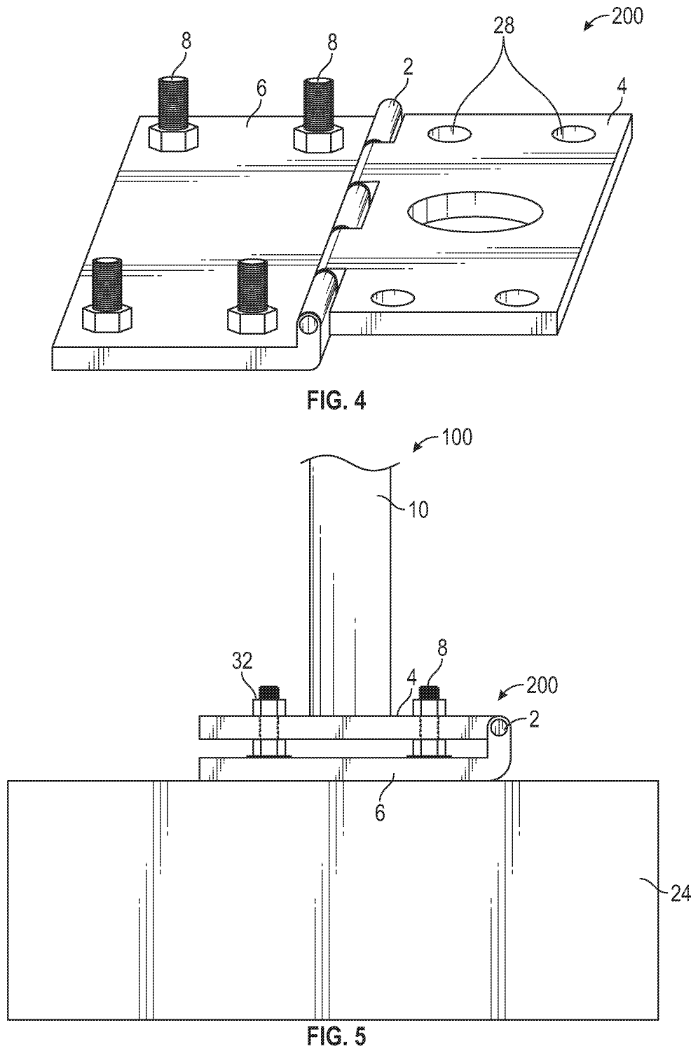

Referring to FIGS. 3 and 4, a perspective view is shown of a hinge assembly 200 in an open position that may be attached to a lightweight antenna pole 10 for quickly deployment in accord with another possible embodiment of the present invention. The hinge 2 is preferably constructed of aluminum to provide a strong, lightweight component. Other materials may also be used such as other metals, composites, wood, or suitable material may be used. The hinge 2 comprises a top bolt bracket 4 and a bottom bolt bracket 6. The top bolt bracket 4 may comprise a plurality of holes 28 corresponding to a plurality of holes 29 in the bottom bolt bracket 6. The lightweight antenna pole 10 may be secured to the top bolt bracket 4 by bolts 8, screws, welding, or the like. Likewise, the bottom bolt bracket 6 may be secured to an anchor by bolts 8, screws, welding, or the like. The antenna pole 10 fit within a larger hole 30 within top bolt bracket 4. After the hinge 2 has been secured to lightweight antenna pole 10 and the anchor 24, the antenna pole 10 may be erected by lifting the pole along the same rotational axis of the hinge.

Referring to FIG. 5, a side view of the hinge in a closed position that may be attached to a lightweight antenna pole for quickly deployment in accord with another possible embodiment of the present invention. In one embodiment, as the hinge 2 is closed, the bolts 8 used to attach the bottom bolt bracket 6 to the anchor 24 may protrude upward relative to the anchor 24. The bolts 8 may pass through the corresponding holes 28 in the top bolt bracket 4. Nuts 32 may then be used to secured the hinge 2 in the closed position and maintain the lightweight antenna pole 10 in the closed position. In other embodiments, other means may be used to secure the top bolt bracket 4 to the bottom bolt bracket 6 such as a pin, cottar pins, latches, or the like.

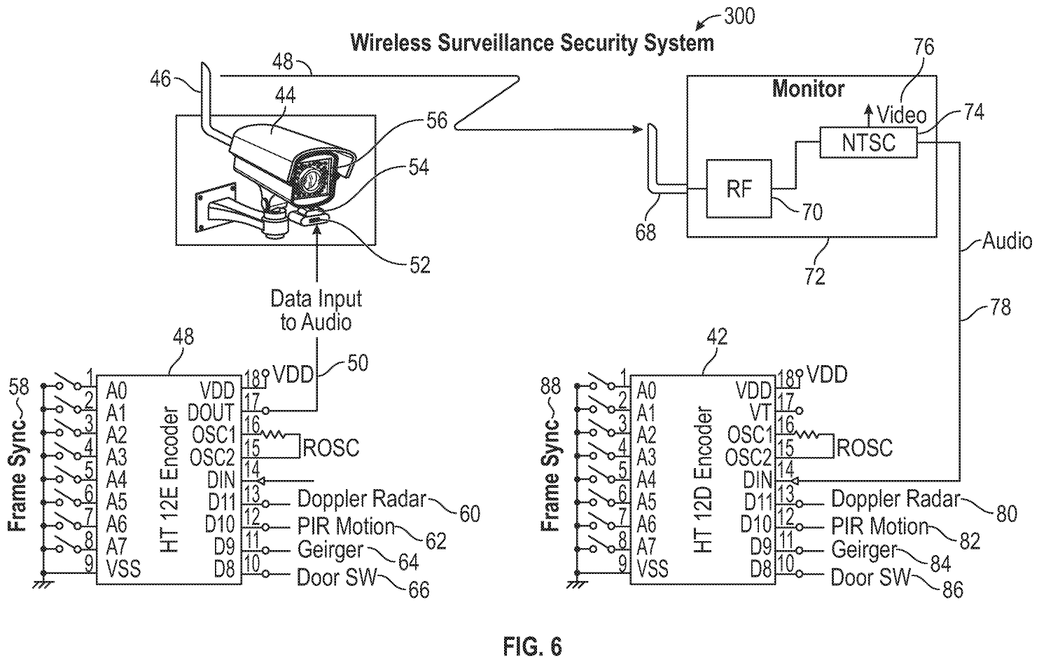

Referring to FIG. 6, is a schematic view of a surveillance system 300 comprising an encoder electronic chip 40 with a set of data inputs wherein the data is transmitted over an audio channel to an antenna which sends the signals to a receiver and decoder chip 42 for viewing by a user or storing on a storage. The encoder electronic chip 40 may be a standard chip with multiple inputs for a plurality of components such as Doppler radar 60, geiger counters 64, PIR motion detectors 62, door switches 66, or the like. A plurality of other desired components may be used such as a video camera, spotlight, rain gauge, radiation detector, paint gun, Doppler radar, radar unit, or other like desired directional sensor or component. While the term directional apparatus is used in the claims, it will be understood that other types of sensors or detectors could also be used such as smoke, fire, CO2 detectors, temperature, wind speed, rain, gas, pollution, radiation, and the like so that motion detectors refers to other types of detectors which could produce information viewed by a particular camera. As well, many types of motion sensor detectors could be used such as radar, thermal, magnetic, ultrasonic or the like. Detectors may or may not be automatically reset after time or may require manual resetting. Data from the plurality of components may be encoded and transmitted 50 to an audio channel port 52 of a camera. The audio input 52 may be a standard audio input such as on a standard surveillance camera or other device. This increases the adaptability to modify any current surveillance system by adding the chips and any other components thereby reducing costs, maintenance, complexity, and increasing ease of use and installation.

In one possible embodiment, Doppler radar 60 could be connected to the audio input port 52 of a camera 53. The camera 53 may also be operable to transmit a video signal 48 at the same time allowing the system or a user to detect any possible motion detected with the Doppler radar 60. This will also allow the system or user simultaneously to still have the ability to visually observe the video for any object or occurrence that triggered the motion alert from the Doppler radar 60. In another possible embodiment, there may be more than one audio input 52. An additional camera audio input could concurrently be connected to a fire alarm to simultaneously monitor the video data for the presence of a fire. Other possible sensors or detectors, as referred to above, may be operable to monitor for any other desired features as well. Utilizing Doppler radar 60 adds increased usefulness to a surveillance system allowing for motion detection from inside a house or at a significant distance. Further, Doppler radar 60 may be able to provide the distance as to how far away the motion occurred once the sensor has been triggered. Prior art motion detectors may be limited to relatively close distances or be unable to penetrate through barriers such as walls, doors, or the like. Therefore, utilizing Doppler radar 60 allows for a substantial increase in effectiveness and a much better motion detector.

The Doppler radar 60 output is dependent on its frequency, for example 10 GHZ. The change in frequency between the radar and target provides an output which can vary between zero for no distance change to around 100 KHZ for a velocity of 60 miles per hour. Therefore adding a one shot of set pulse duration to output for an on off signal. However, a digital velocity can be sent by a combination of the 4 binary data by the digital encoder and decoder.

In one possible embodiment, the surveillance system may be able to utilize a total of four cameras. One camera may be connected to a first electronic encoder chip 40 which may use an audio input 52 with a video frame sync 58 while another encoder may be connected to a PIR input 62 with another video frame sync 58. The first input may be transmitted using one camera with four on/off signals with the second input using a four binary level signal along with the video signal concurrently. Alternatively, the audio signal input and the motion input signal could use an encoder which could send eight on/off signals at same time as a video signal.

Also the radar, fire alarm, other radar, and door and window switch could be time multiplexed so more on off signals could be transmitted. Multiplexing is a method by which multiple analog or digital signals are combined into one signal over a shared medium. The aim is to share a scarce resource such as a single cable or wire. The multiplexed signal is transmitted over a communication channel such as a cable. The multiplexing divides the capacity of the communication channel into several logical channels, one for each message signal or data stream to be transferred. A reverse process, known as demultiplexing, extracts the original channels on the receiver end. several variable bit-rate data streams are multiplexed together to a fixed bitrate transport stream by means of statistical multiplexing. This makes it possible to transfer several video and audio channels simultaneously over the same frequency channel, together with various services. If the encoder 40 and decoder 42 is used, they may be turned off and on and timed multiplexed with frame sync to send a plurality of on/off signals or up to 16 level digital signal. The wireless system allows many possibilities to send messages because the audio and motion input are separated and then combined to an NTSC signal 74 which may then further be separated at the receiver 68 into an video 76 and audio output 78.

The encoder electronic chip 40 may comprises a plurality of inputs such as Doppler radar 60, PIR motion detector 62, Geiger counter 64, and a door switch 66. The signals produced by each input may be frame synced 58 so that each may be more easily viewed by a user with corresponding date and times. The data is encoded and transmitted 50 to an audio input 52 on the camera 53. The camera may have other devices attached or mounted to it such as PIR motion detectors 54, microphone 55, and an infrared detector 56. Additional devices may be utilized as desired as well. The camera 53 may also comprise a high gain antenna (HGA) 46 capable of transmitting at 2.8 MHz. The data is transmitted 48 to receiver antenna 68 attached to a monitor system 72. The receiver antenna may also be a HGA capable of receiving the 2.8 GHz signal. The receiver antenna 68 sends the signal to an RF receiver 70 and a NTSC receiver which may then produce a video signal 76 and output the data via an audio port 78. The data is output to a electronic decoder chip 42. The decoder chip 42 may have a plurality of corresponding inputs such as Doppler radar 80, PIR motion detector 82, Geiger counter 84, and door switch 86. The signals may be frame synced 88 to allow a user to view the various components signals at the same time with the same date and time.

The foregoing description of the preferred embodiments of the invention has been presented for purposes of illustration and description only. It is not intended to be exhaustive or to limit the invention to the precise form disclosed; and obviously many modifications and variations are possible in light of the above teaching. While redundant, different methods discussed above could be utilized together if desired. Such modifications and variations that may be apparent to a person skilled in the art are intended to be included within the scope of this invention as defined by the accompanying claims.

1. A lightweight surveillance system, comprising:
an antenna pole, said antenna pole having a top mount and a bottom mount;
a hinge comprising a top bolt bracket and a bottom bracket, said top bracket secured to said antenna pole at said bottom mount;
an anchor, said anchor being secure to said bottom bracket, said anchor being weighted to securely maintain said antenna pole in an upright position; and
a motor comprising a rotatable bracket mounted to said top bracket of said antenna pole.

2. The lightweight surveillance system of claim 1, wherein said antenna pole being erected by coupling said top bolt bracket to said bottom bolt bracket.

3. The lightweight surveillance system of claim 1, wherein said motor is electronically controlled to operate bidirectionally or pause to take motion measurement.

5. The lightweight surveillance system of claim 1, further comprising a light mounted on said rotatable bracket.

6. The lightweight surveillance system of claim 1, further comprising a Doppler radar or PIR detection unit mounted on said rotatable bracket.

7. The lightweight surveillance system of claim 1, providing said motor rotates continuously in one direction, wherein said motor is operable to rotate up to 360 degrees.

8. A wireless surveillance system comprising:
an electronic encoder chip, said electronic encoder chip further comprising a plurality of data inputs wherein data from said plurality of data inputs is transmitted to an audio input port of a camera;
a transmitter antenna operably connected to said camera wherein said data is transmitted;
a receiver antenna operably connected to a monitor system, said monitor system having an audio output port; and
an electronic decoder chip further comprising a plurality of data inputs wherein said data from said plurality of data inputs is input to said electronic decoder chip.

9. The wireless surveillance system of claim 8, further comprising said plurality of data inputs includes at least one of a Doppler radar, PIR motion detector, a Geiger counter, and/or a door switch.

10. The wireless surveillance system of claim 8, further comprising said camera comprises a high gain antenna.

11. The wireless surveillance system of claim 8, further comprising said monitor system comprises an RF receiver, an NTSC receiver, and a video output.

12. The wireless surveillance system of claim 8, further comprising said electronic encoder chip and said electronic decoder chip are operable to frame sync said data.

13. The wireless surveillance system of claim 8, further comprising said camera comprises more than one audio input port operable to receiver data.
